(19) United States
(12) Patent Application Publication
(10) Pub. No.: US 2025/0051124 A1
(43) Pub. Date: Feb. 13, 2025

(54) INFORMATION TERMINAL DEVICE, ROLL PAPER PRINTER FOR INCORPORATION WITH INFORMATION TERMINAL DEVICE, AND PAPER GUIDE

(71) Applicant: SEIKO EPSON CORPORATION, Tokyo (JP)

(72) Inventor: Koji YAMADA, OKAYA-SHI (JP)

(21) Appl. No.: 18/794,034

(22) Filed: Aug. 5, 2024

(30) Foreign Application Priority Data
Aug. 8, 2023 (JP) 2023-129062

(51) Int. Cl. B65H 29/20; B65H 29/52; B65H 29/56

(52) U.S. Cl. CPC B65H 29/20; B65H 29/52; B65H 29/56; B65H 2404/1544

(57) ABSTRACT

An information terminal device includes a roll paper printer that pulls out paper from paper roll, performs printing, and cuts the paper, a paper guide that guides the paper, and an issue port through which the paper is discharged, wherein the paper guide includes a first guide for guiding a first surface of the paper, a roller for guiding a second surface of the paper being a surface opposite to the first surface at a position facing the first guide, and a support portion permitted to movably support a shaft of the roller.

The present application is based on, and claims priority from JP Application Serial Number 2023-129062, filed Aug. 8, 2023, the disclosure of which is hereby incorporated by reference herein in its entirety.

### BACKGROUND

### 1. Technical Field

The present disclosure relates to an information terminal device, a roll paper printer for incorporation with an information terminal device, and a paper guide.

### 2. Related Art

In the related art, as disclosed in JP 2008-68950 A, there is known a device that performs printing using roll paper and includes a cutting blade for cutting a sheet of paper and a sheet discharge guide disposed at a sheet discharge port.

In the above-described device, there is a risk that a cut and discharged sheet of paper falls from the sheet discharge guide.

### SUMMARY

An information terminal device for solving the above-described problem includes a roll paper printer configured to pull out paper from paper roll, perform printing, and cut the paper, a paper guide configured to guide the paper, and an issue port through which the paper is discharged, wherein the paper guide includes a first guide for guiding a first surface of the paper, a roller for guiding a second surface of the paper being a surface opposite to the first surface at a position facing the first guide, and a support portion permitted to movably support a shaft of the roller.

A roll paper printer for incorporation with an information terminal device for solving the above-described problem is a roll paper printer for incorporation with an information terminal device including a paper guide including a first guide for guiding a first surface of paper, a roller for guiding a second surface of the paper being a surface opposite to the first surface at a position facing the first guide, and a support portion permitted to movably support a shaft of the roller, and an issue port through which the paper is discharged, the roll paper printer including a platen roller configured to pull out the paper from roll paper and configured to transport the paper to the issue port via the paper guide, a head configured to perform printing on the paper at a position facing the platen roller, and a cutter configured to cut the paper.

A paper guide for solving the above-described problem is a paper guide for guiding paper discharged from a roll paper printer that pulls out the paper from paper roll, performs printing, and cuts the paper, the paper guide including a first guide configured to guide a first surface of the paper, a roller configured to guide a second surface of the paper being a surface opposite to the first surface at a position facing the first guide, and a support portion configured to movably support a shaft of the roller.

### BRIEF DESCRIPTION OF THE DRAWINGS

FIG. 1 is an external view of an information terminal device.

FIG. 2 is a cross-sectional view illustrating a main part related to paper transportation of the information terminal device.

FIG. 3 is a cross-sectional view illustrating a paper guide according to a first embodiment.

FIG. 4 is a cross-sectional view illustrating a paper guide according to a second embodiment.

FIG. 5 is a cross-sectional view illustrating a main part of the paper guide.

FIG. 6 is a cross-sectional view illustrating a main part of the paper guide when a first sheet of paper enters the paper guide.

FIG. 7 is a cross-sectional view illustrating a main part of the paper guide when the first sheet of paper is held by the paper guide.

FIG. 8 is a cross-sectional view illustrating a main part of the paper guide when the first sheet of paper is overlaid on a second sheet of paper and enters the paper guide.

FIG. 9 is a cross-sectional view illustrating a main part of the paper guide when the first sheet of paper presses and moves the second sheet of paper.

FIG. 10 is a cross-sectional view illustrating a main part of the paper guide when the first sheet of paper presses and drops the second sheet of paper.

### DESCRIPTION OF EMBODIMENTS

Hereinafter, embodiments will be described with reference to the drawings. Note that directions in the drawings will be described using a three dimensional coordinate system. For convenience of explanation, a positive direction of a Z-axis is referred to as an upward direction, an upper side, or simply above, a negative direction is referred to as a downward direction, a lower side, or simply below, a positive direction of an X-axis is referred to as a rightward direction, a right side, or simply right, a negative direction is referred to as a leftward direction, a left side, or simply left, a positive direction of a Y-axis is referred to as a forward direction, a front side, or simply front, and a negative direction is referred to as a rearward direction, a rear side, or simply rear.

### 1. Configuration of Information Terminal Device

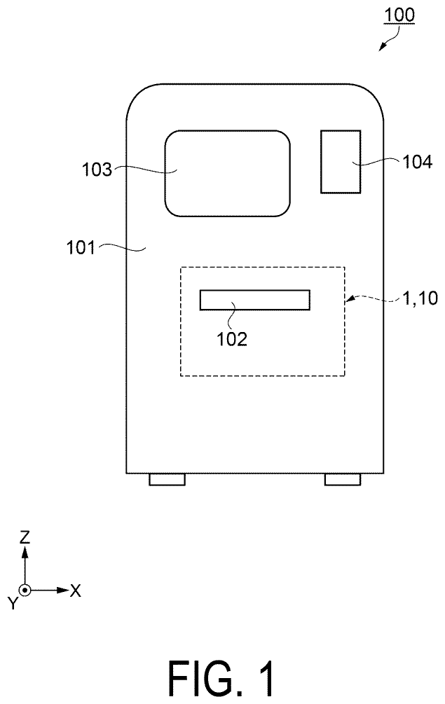

An information terminal device 100 illustrated in FIG. 1 is, for example, a so-called KIOSK terminal. The KIOSK terminal is used for procedures such as provision of service information, various payments, and reception.

A roll paper printer 1 and a paper guide 10 are incorporated inside the information terminal device 100. Further, in the information terminal device 100, a case 101 is provided with a touch panel 103, a reader 104, and an issue port 102.

Note that details of the roll paper printer 1 and the paper guide 10 will be described later.

The touch panel 103 includes a display device such as a liquid crystal display, and an input device that detects an operation on a displayed screen. A customer operates the screen based on a displayed menu by using the touch panel 103.

The information terminal device 100 includes a control unit (not illustrated) including a processor and a memory. The memory stores a program. The processor reads the program from the memory and executes the program. The control unit performs various processes based on the operation detected by the touch panel 103.

The reader 104 can read an IC supported by a customer's card or a portable terminal, or information such as a two dimensional code.

For example, in a hospital or the like, the information terminal device 100 acquires information including customer identification information from a customer's card or mobile terminal by the reader 104, prints a reception slip by the roll paper printer 1, and discharges the reception slip from the issue port 102 via the paper guide 10.

Further, in a retail shop or the like, the information terminal device 100 acquires information including payment information from a customer's card by the reader 104 for making payment, prints a receipt by the roll paper printer 1, and discharges the receipt from the issue port 102 via the paper guide 10. In this case, the information terminal device 100 may be provided with a so-called automatic change machine having functions of depositing and dispensing cash.

When the case 101 of the information terminal device 100 is opened, the roll paper printer 1 and the paper guide 10 are exposed, and a serviceman can perform maintenance or the like.

### 2. Configuration of Roll Paper Printer

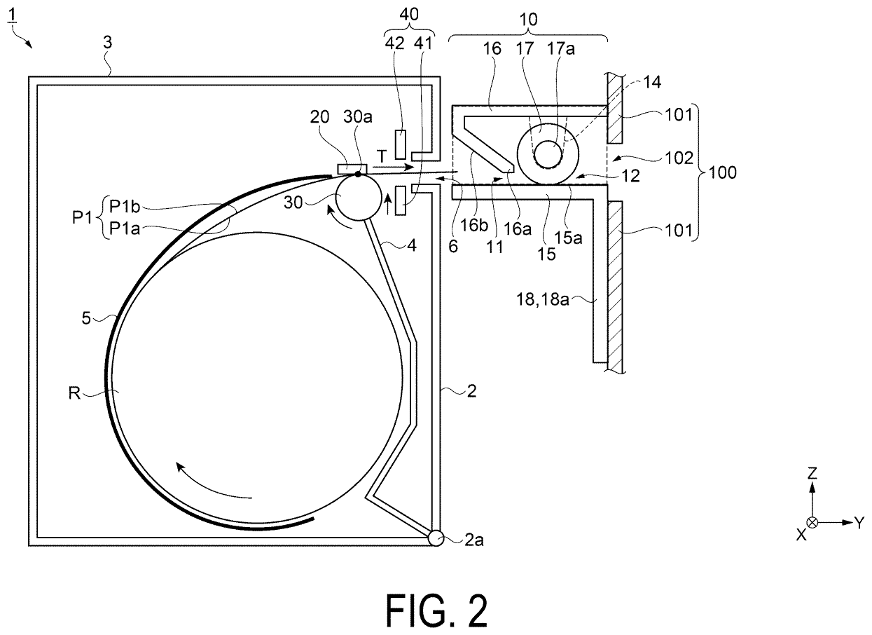

The roll paper printer 1 is a roll paper printer for incorporation with the information terminal device 100. As illustrated in FIG. 2, the roll paper printer 1 is configured to include a printer case 3 that can accommodate roll paper R and a cover 2 that can open and close the printer case 3. The cover 2 is rotatable about a hinge 2a of the printer case 3. After opening the case 101 of the information terminal device 100, the serviceman can open the cover 2 of the roll paper printer 1, thus the roll paper R can be accommodated in the printer case 3.

A platen roller 30, a first blade 41 constituting a cutter 40, and a first roll paper guide 4 are mounted at the cover 2. On the other hand, a head 20, a second blade 42 constituting the cutter 40, and a second roll paper guide 5 are mounted at the printer case 3.

When the cover 2 is closed, the platen roller 30 and the head 20 are located to face each other, and the first blade 41 and the second blade 42 of the cutter 40 are located to face each other. The cutter 40 is located downstream in a transport direction T with respect to the platen roller 30 and the head 20.

Further, when the cover 2 is closed, a rectangular paper discharge port 6 is formed between the cover 2 and the printer case 3. The roll paper R is rotatably supported by the first roll paper guide 4 of the cover 2, and the second roll paper guide 5 of the printer case 3.

The platen roller 30 is formed in a cylindrical shape by a material such as a flexible resin such as rubber.

The platen roller 30 and the head 20 nip a first sheet of paper P1 at a nip position 30a. The platen roller 30 transports the first sheet of paper P1 by a friction feed method, which is a method of transporting by friction. The platen roller 30 is a so-called transport roller that transports the first sheet of paper P1. The platen roller 30 rotates clockwise, pulls out the first sheet of paper P1 from the roll paper R accommodated in the printer case 3, and transports the first sheet of paper P1 in the transport direction T. At this time, the roll paper R also rotates clockwise.

Note that sheets of paper wound around the roll paper R, pulled out from the roll paper R, subjected to printing, and cut, including the first sheet of paper P1 and a second sheet of paper P2 described later, are collectively referred to as sheets of paper P.

The platen roller 30 can transport the sheet of paper P to the issue port 102 of the information terminal device 100 via the paper guide 10.

The head 20 is a line thermal head, for example. The head 20 includes a pressing mechanism (not illustrated) that performs pressing toward the platen roller 30. The first sheet of paper P1 is nipped by the platen roller 30 and the head 20 at the nip position 30a with a predetermined pressing force by the pressing mechanism.

The sheet of paper P is, for example, an elongated thermal paper. A first surface P1a of the first sheet of paper P1 is a transport surface transported by the platen roller 30. A second surface P1b of the first sheet of paper P1 being a surface opposite to the first surface P1a is a printing surface coated with a color coupler.

While the first sheet of paper P1 is transported with the first surface P1a in contact with the platen roller 30, the second surface P1b comes into contact with the head 20 at the nip position 30a, and color is developed by heat generation of the head 20 to perform printing. Note that in the roll paper R, the sheet of paper P is wound around so that an outer side becomes a printing surface.

The roll paper printer 1 includes a printer control unit (not illustrated). The printer control unit is configured to include a processor that overall controls each unit of the roll paper printer 1, a memory, and the like. The memory stores a program. The processor reads the program from the memory and performs control in various ways.

The printer control unit can perform control for pulling out the sheet of paper P from the roll paper, transporting the sheet of paper P by the platen roller 30, performing printing by the head 20, and cutting the sheet of paper P by the cutter 40, for example.

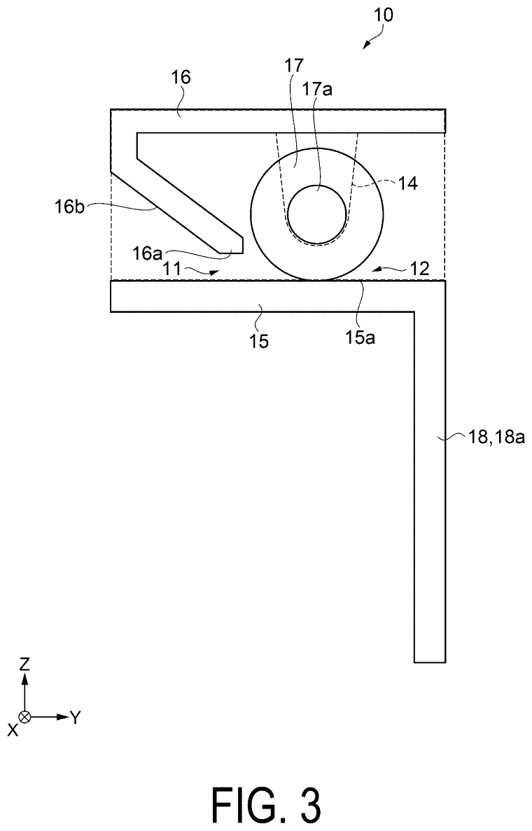

3. Configuration of Paper Guide of First Embodiment The paper guide 10 of the first embodiment will be described with reference to FIG. 2 and FIG. 3. As illustrated in FIG. 2, in the information terminal device 100, the paper guide 10 for guiding the first sheet of paper P1 is mounted at the case 101. The paper guide 10 includes a first opening 11 through which the first sheet of paper P1 is entered from the rear side, and a second opening 12 through which the first sheet of paper P1 is put out to the front side.

Furthermore, the paper guide 10 includes a first guide 15 that can guide the first sheet of paper P1 from below, a roller 17 that can guide the first sheet of paper P1 from above, a second guide 16 that covers the roller 17 from above, and an attachment plate 18 for attaching the paper guide 10 to the case 101.

An attachment tool 18a is a double-sided tape, an adhesive, or the like, and fixes the attachment plate 18 of the paper guide 10 to an inside of the case 101. Note that the attachment tool 18a may be a screw or the like, and can detachably attach the attachment plate 18 to the inside of the case 101.

As a result, the second opening 12 of the paper guide 10 is located to communicate with the issue port 102 formed as a rectangular hole at the case 101, so that the first sheet of paper P1 can be put out to the issue port 102. Further, when the case 101 is closed, the first opening 11 of the paper guide 10 is located to communicate with the paper discharge port 6 of the roll paper printer 1 so that the first sheet of paper P1 discharged from the paper discharge port 6 can be entered.

The first sheet of paper P1 transported in the transport direction T by the platen roller 30 of the roll paper printer 1 and discharged from the paper discharge port 6 enters the first opening 11, which is an entrance of the paper guide 10. At this time, the first sheet of paper P1 can smoothly enter the first opening 11 while being guided from above by an inclined surface 16b of the second guide 16 which is inclined to a front-lower side toward the first guide 15.

In the paper guide 10, the roller 17 is located to face the first guide 15. In the first sheet of paper P1 entering the first opening 11, the first surface P1a is guided from below by the first guide 15, and the second surface P1b is guided from above by the roller 17.

An upper side of the first opening 11 of the paper guide 10 is defined by an end portion 16a which is a front lower tip of the inclined surface 16b of the second guide 16, and a lower side thereof is defined by the first guide 15.

The first opening 11 communicates with the second opening 12, which is an exit for the first sheet of paper P1 in the paper guide 10, in the forward direction as the transport direction T. The first sheet of paper P1 is transported in the transport direction T by the platen roller 30 of the roll paper printer 1, enters the paper guide 10 through the first opening 11, and comes out from the second opening 12. As will be described later, at this time, the first sheet of paper P1 is pressed from above with a pressing force W by the roller 17. The upward and downward directions of the second opening 12 are defined by the roller 17 and the first guide 15, respectively.

Note that the leftward and rightward directions of the first opening 11 and the second opening 12 may be defined by plate-like portions rising to the upper side from left and right ends of the first guide 15, or plate-like portions falling to the lower side from left and right ends of the second guide 16, which face each other. Thus, the first sheet of paper P1 can be guided from left and right.

A portion of the first guide 15 that comes into contact with the first sheet of paper P1 is configured as a flat surface in the forward, rearward, leftward, and rightward directions. The first guide 15 is made of resin such as polyethylene, for example.

At least a portion of the first guide 15 that comes into contact with the first sheet of paper P1 is covered with a sheet 15a containing, for example, ultra-high-molecular-weight polyethylene.

Ultra-high-molecular-weight polyethylene has molecular weight increased to 1,000,000 to 7,000,000 while molecular weight of normal polyethylene is 20,000 to 300,000. The sheet 15a made of ultra-high-molecular-weight polyethylene can reduce friction with an object in contact therewith as compared with polyethylene or the like. In addition, the sheet 15a made of ultra-high-molecular-weight polyethylene can suppress static electricity generated between the sheet 15a and an object in contact therewith, as compared with polyethylene or the like, and can further reduce friction. The sheet 15a containing ultra-high-molecular-weight polyethylene is also referred to as a so-called low-friction sheet. As will be described later, a friction coefficient of the sheet 15a is smaller than a friction coefficient of the sheet of paper P. Therefore, a friction force between the sheet 15a and the sheet of paper P is smaller than a friction force between the sheets of paper P.

The first guide 15 can guide the first surface P1a of the first sheet of paper P1. The roller 17 can guide the second surface P1b of the first sheet of paper P1 being the surface opposite to the first surface P1a at a position facing the first guide 15.

As will be described later, the first sheet of paper P1 can be guided and held by the first guide 15 and the roller 17.

The second guide 16 is disposed above and on an opposite side of the first guide 15 with the roller 17 interposed. Note that on the roller 17 side of an upper side of the second guide 16, a plurality of arc-shaped ribs may be provided along a circumference of the roller 17 so as to hold down the roller 17 that has sprung up. Because, as will be described later, an upper side of a groove-shaped support portion 14 is opened, and thus the roller 17 may spring to the upper side together with a shaft 17a depending on behavior of the first sheet of paper P1.

The roller 17 is made of resin such as plastic or rubber and formed in a cylindrical shape. The roller 17 is rotatable about the shaft 17a by coming into contact with the first sheet of paper P1 entering from the first opening 11.

Note that the roller 17 may be constituted by a plurality of rollers, and a ring-shaped rib may be partially provided at a circumference. The roller 17 having such a configuration can come into contact with the first sheet of paper P1 in a well-balanced manner in a paper width direction.

A lower side of the support portion 14 facing a plane of the first guide 15 has an arc shape, and includes a groove extending to the upper side, that is, in a direction away from the plane of the first guide 15. The upper side of the groove-shaped support portion 14 is opened. The support portion 14 having such a shape can movably support the shaft 17a. In addition, the support portion 14 can smoothly move the roller 17 and the shaft 17a pressed by the first sheet of paper P1 while being in contact with the shaft 17a.

The support portion 14 are provided at left and right positions of the shaft 17a and can support the shaft 17a. Note that the support portion 14 may be provided at the first guide 15 or the second guide 16. The left and right support portions 14 may be provided at plate-like portions rising to the upper side from the left and right ends of the first guide 15 so as to face each other. Alternatively, the left and right support portions 14 may be provided at plate-like portions extending to the lower side from the left and right ends of the second guide 16 so as to face each other.

The support portion 14 may be formed integrally with the first guide 15 or the second guide 16 by resin.

When the support portion 14 is provided at the first guide 15, since the support portion 14 has a groove shape, it is possible to easily incorporate the roller 17 by throwing the roller 17 from the open upper side of the support portion 14.

On the other hand, when the support portion 14 is provided at the second guide 16, the support portion 14 and the second guide 16 can be handled as a unit to which the roller 17 is assembled. For example, the support portion 14 and the second guide 16, as a unit to which the roller 17 is assembled, can be easily assembled or replaced with respect to the first guide 15.

### 4. Configuration of Paper Guide of Second Embodiment

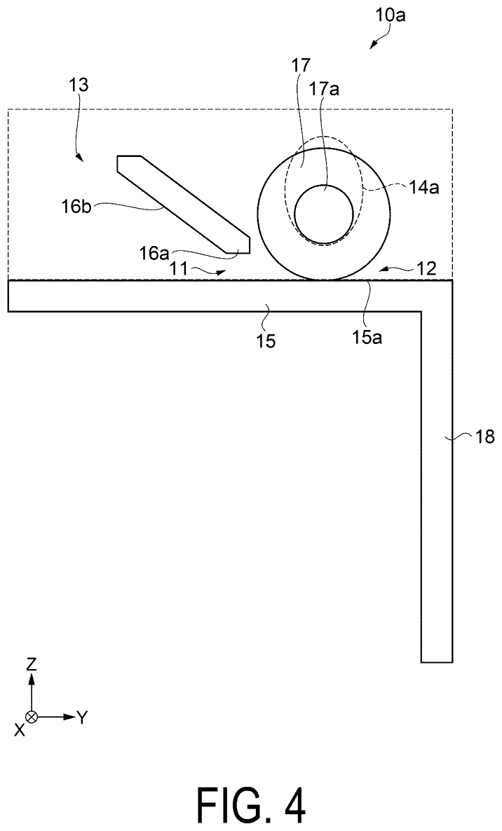

A paper guide 10a of a second embodiment will be described with reference to FIG. 4. The paper guide 10a will be described focusing on differences from the paper guide 10 of the first embodiment described above, and description of the same configuration as that of the paper guide 10 will be omitted. Note that in FIG. 4, the same components as those of the paper guide 10 of the first embodiment are denoted by the same reference numerals.

A support portion 14a of the paper guide 10a of the second embodiment is a long hole having a vertically long elliptical shape. The support portion 14a having such a shape can movably support the shaft 17a. In addition, the support portion 14a can smoothly move the roller 17 and the shaft 17a pressed by the first sheet of paper P1 while being in contact with the shaft 17a.

The support portions 14a are provided at the left and right positions of the shaft 17a and can support the shaft 17a. Note that the support portion 14a may be provided at the first guide 15. The left and right support portions 14a may be configured as plate-like portions rising to the upper side from the left and right ends of the first guide 15 so as to face each other. In addition, the support portion 14a may be formed integrally with the first guide 15 by resin.

When the support portion 14a is provided at the first guide 15, and the roller 17 is assembled to the support portion 14a, those components can be handled as a unit. For example, the support portion 14a and the first guide 15 can be easily assembled or replaced as a unit to which the roller 17 is assembled.

As described above, the first sheet of paper P1 is transported in the transport direction T from the first opening 11 of the paper guide 10a via the second opening 12 by the platen roller 30 of the roll paper printer 1, and is discharged from the issue port 102. At this time, the first sheet of paper P1 coming out from the issue port 102 may be held down or grasped by a hand of the customer.

In this case, the first sheet of paper P1 in the paper guide 10a cannot come out from the second opening 12, whereas the first sheet of paper P1 to be subsequently transported is to enter from the first opening 11. As a result, there is a risk that the first sheet of paper P1 is jammed inside the paper guide 10a.

The paper guide 10a has a configuration in which a portion of the second guide 16 that covers the roller 17 from above is removed from the paper guide 10. As a result, a third opening 13 is formed on an upper side of the paper guide 10.

The third opening 13 communicates with the first opening 11 on an upper rear side. When the first sheet of paper P1 cannot come out from the second opening 12 due to the customer holding down the first sheet of paper P1 at the issue port 102, the third opening 13 allows the first sheet of paper P1 to be put out in a direction different from the second opening 12.

That is, the first sheet of paper P1 newly entering through the first opening 11 can come out through the third opening 13 to the upper side, which is a direction different from the transport direction T. The third opening 13 allows the first sheet of paper P1 which cannot come out from the second opening 12 to be released.

Note that similarly to the paper guide 10, the paper guide 10a has the inclined surface 16b. Then, similarly to the paper guide 10, in the paper guide 10a, the upper side of the first opening 11 is defined by the end portion 16a which is the front lower tip of the inclined surface 16b.

In this case, the inclined surface 16b of the paper guide 10a is configured to extend from the left and right ends of the first guide 15. Alternatively, the inclined surface 16b may be integrally molded with the first guide 15 by resin.

### 5. Operation of Main Part of Paper Guide 10

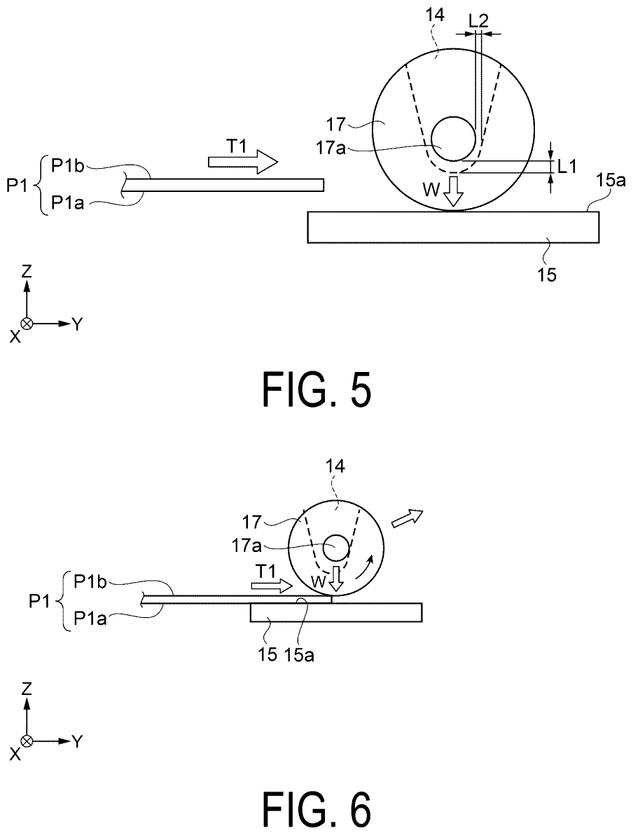

Next, operation of a main part of the paper guide 10 will be described with reference to FIG. 5 to FIG. 10. Note that in the following description, an example of the groove-shaped support portion 14 of the paper guide 10 of the first embodiment will be described, but the same applies to the case of the long hole-shaped support portion 14a of the paper guide 10a of the second embodiment.

As illustrated in FIG. 5, the first sheet of paper P1 discharged from the paper discharge port 6 (not illustrated) of the roll paper printer 1 is transported in a transport direction T1, and is headed to a gap between the roller 17 and the first guide 15. Note that the first sheet of paper P1 is in a state before being cut by the cutter 40 (not illustrated), and is transported in the transport direction T1 by the platen roller 30 (not illustrated) of the roll paper printer 1 located on a rear side of the roller 17 and the first guide 15. Then, the first sheet of paper P1 is discharged from the issue port 102 (not illustrated) of the information terminal device 100.

The roller 17 is in contact with the first guide 15 via the sheet 15a and presses the first guide 15 with the pressing force W. In this case, the pressing force W is generated by own weight of the roller 17 including the shaft 17a. Note that the pressing force W may be generated via the roller 17 by a spring, rubber, or the like (not illustrated).

The pressing force W may be in a range of 5 gf to 30 gf, and more desirably 7 gf. Note that, for example, an outer diameter of the roller 17 is 7 mm, and an outer diameter of the shaft 17a is 3 mm.

When the roller 17 is in contact with the first guide 15 via the sheet 15a, gaps each having a distance L2 can be provided between the shaft 17a of the roller 17 and the support portion 14 on the front and rear sides, respectively, and a gap having a distance L1 can be provided on the lower side. For example, the distance L2 may be 0.5 mm, and the distance L1 may be 1 mm.

The shaft 17a is movable over a length of the distance L2 to each of the front and rear sides of the support portion 14. In addition, since the shaft 17a is separated from the lower side of the support unit 14 by the distance L1, the shaft 17a can be in a state of floating from the support portion 14 together with the roller 17, and as will be described later, the roller 17 can reliably press the first sheet of paper P1 with the pressing force W.

Note that when the roller 17 is in contact with the first guide 15 via the sheet 15a, the shaft 17a can be separated from the support portion 14 by the distances L1 and L2, and therefore, as illustrated in FIG. 5, the shaft 17a is permitted not to be in contact with the support portion 14.

The support portion 14 is configured as a so-called U-shaped groove. The portion located on the lower side of the support portion 14 facing the plane of the first guide 15 has an arc shape in accordance with a shape of the shaft 17a.

The support portion 14 includes a front-upper inclined surface extending to the upper side in the forward direction and a rear-upper inclined surface extending to the upper side in the rearward direction from the arc-shaped portion on the lower side. The front-upper inclined surface is also referred to as a first inclined surface, and the rear-upper inclined surface is also referred to as a second inclined surface. The two inclined surfaces extend obliquely to the upper side so as to be away from each other on the front and rear sides of the arc-shaped portion of the support portion 14. That is, the two inclined surfaces are slightly obliquely opposed to each other, and have shapes spreading toward the upper side from the arc-shaped portion.

Note that, in the U-shape, the surfaces extending to the upper side need not be configured as the inclined surfaces. For example, the surfaces may be constituted by vertical surfaces extending vertically to the upper side, or may be constituted by a combination of the inclined surface and the vertical surface.

Note that the support portion 14a of the second embodiment has the same configuration as that of the support portion 14 of the first embodiment, although the shape of the support portion 14a is a long hole.

With the support portion 14 having such a configuration, the shaft 17a of the roller 17 can freely move within a range of the support portion 14. Further, when the shaft 17a comes into contact with the support portion 14, the shaft 17a can smoothly move along one of the two inclined surfaces. The roller 17 can be similarly moved together with the shaft 17a.

When the first sheet of paper P1 illustrated in FIG. 5 is further transported in the transporting direction T1, a tip of the first sheet of paper P1 enters the gap between the roller 17 and the first guide 15 as illustrated in FIG. 6.

The roller 17 comes into contact with and is pressed by the tip of the first sheet of paper P1, and is lifted to the upper side while moving to the front side. Further, the roller 17 can press the first sheet of paper P1 with the pressing force W while rotating counterclockwise. At this time, the shaft 17a of the roller 17 also moves in a front-upper direction. The shaft 17a, while being in contact with the front-upper inclined surface of the support portion 14, can smoothly move in the front-upper direction together with the roller 17 along the front-upper inclined surface. Further, the shaft 17a also rotates counterclockwise together with the roller 17.

As described above, since the support portion 14 movably supports the shaft 17a of the roller 17, the transported first sheet of paper P1 presses the roller 17, and can smoothly move the shaft 17a together with the roller 17.

The roller 17 is pressed by the tip of the first sheet of paper P1 and can move so as to float while rotating. Therefore, the tip of the first sheet of paper P1 can easily slide into the lower side of the roller 17. That is, by the support portion 14 having such a configuration, a load when the tip of the first sheet of paper P1 enters the gap between the first guide 15 and the roller 17 is reduced, and the tip can be easily entered.

To be more specific, as illustrated in FIG. 5, when the roller 17 comes into contact with the first guide 15 via the sheet 15a, the shaft 17a of the roller 17 can be located so as not to come into contact with the support portion 14. At this time, as described above, due to the distance L1 and the distance L2, the gaps are formed such that the shaft 17a does not come into contact with the support portion 14.

As illustrated in FIG. 6, the first sheet of paper P1 enters the gap between the roller 17 and the first guide 15, and the roller 17 comes into contact with the first sheet of paper P1. At this time, due to these gaps, the roller 17 can move to the front, rear, upper, and lower sides together with the shaft 17a. Therefore, the first sheet of paper P1 can easily slides into the lower side of the roller 17, and the roller 17 can press the first sheet of paper P1 with the pressing force W due to the own weight.

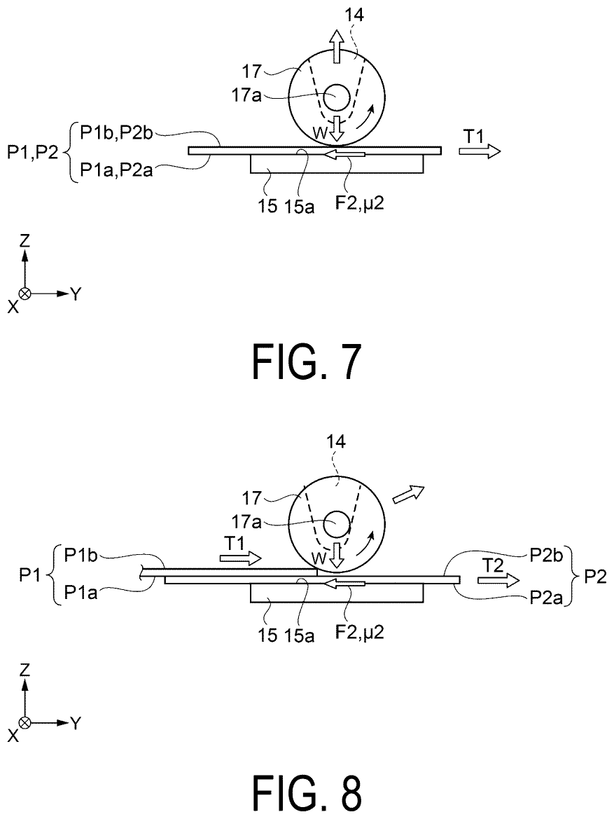

When the first sheet of paper P1 illustrated in FIG. 6 is further transported in the transport direction T1, as illustrated in FIG. 7, the first sheet of paper P1 advances while being pressed by the roller 17 on the upper side with the pressing force W and being guided by the roller 17 and the first guide 15. Next, the first sheet of paper P1 is cut by a predetermined length by the cutter 40 located at a position on the rear side of the roller 17 and the first guide 15. For example, when the first sheet of paper P1 is issued as a receipt, the predetermined length is about 70 mm. Depending on printed contents, such as the number of items to be purchased, the receipt may be shorter than 70 mm or longer than 70 mm.

Hereinafter, the first sheet of paper P1 before being cut by the cutter 40 is referred to as first sheet of paper P1 as it is, and the first sheet of paper P1 which is cut to be a piece of paper is also referred to as a second sheet of paper P2.

The roller 17 is pressed by the first sheet of paper P1 present between the roller 17 and the first guide 15, and moves to the upper side from the position illustrated in FIG. 5 by a thickness of the first sheet of paper P1. At this time, the shaft 17a of the roller 17 is also moved to the upper side from the position illustrated in FIG. 5 by the thickness of the first sheet of paper P1 in the support portion 14. The thickness of the first sheet of paper P1 is, for example, in a range of 50 μm to 90 μm.

Note that although FIG. 7 illustrates a case where the shaft 17a is not in contact with the support portion 14, the shaft 17a may be in contact with the first inclined surface or the second inclined surface of the support portion 14.

Here, a friction coefficient between a first surface P2a of the second sheet of paper P2 and the sheet 15a of the first guide 15 is a second friction coefficient μ2. When the second sheet of paper P2 is about to move in the transport direction T1, a second friction force F2 due to the second friction coefficient μ2 is generated between the first surface P2a of the second sheet of paper P2 and the sheet 15a in a direction opposite to the transport direction T1.

The second friction force F2, the second friction coefficient μ2, and the pressing force W by the roller 17 have a relationship of F2=μ2×W. That is, the second friction force F2 has a value obtained by multiplying the second friction coefficient μ2 by the pressing force W. Note that the second friction coefficient μ2 may be in a range of 0.05 to 0.2, and more desirably 0.1.

The second sheet of paper P2 can be pressed by the pressing force W from the roller 17 and held in a state of being nipped by the first guide 15 and the roller 17. Furthermore, the second friction force F2 acting in the direction opposite to the transport direction T1, which is a direction in which the second sheet of paper P2 falls, is generated. As a result, the second sheet of paper P2 is prevented from falling from the first guide 15. That is, the second sheet of paper P2 is prevented from falling from the issue port 102 of the information terminal device 100.

For example, the second sheet of paper P2 subjected to printing by the head 20, cut by the cutter 40, and issued as a receipt can be held by the pressing force W of the roller 17 or the like in a state of being placed on the first guide 15. The customer can easily take out the second sheet of paper P2, which is the receipt held without falling from the first guide 15, from the issue port 102.

FIG. 8 illustrates a case where the next first sheet of paper P1 is transported in a state where the second sheet of paper P2 placed on the first guide 15 is not taken out and remains.

The next first sheet of paper P1 discharged from the paper discharge port 6 is transported in the transport direction T1 by the platen roller 30 of the roll paper printer 1. A tip of the first sheet of paper P1 enters the gap between the roller 17 and the first guide 15 while being overlaid on the second sheet of paper P2 placed on the first guide 15.

The roller 17 comes into contact with and is pressed by the tip of the first sheet of paper P1, and is further lifted to the upper side while moving to the front side. Further, the roller 17 can press the overlapping first sheet of paper P1 and second sheet of paper P2 with the pressing force W while rotating counterclockwise.

At this time, the shaft 17a of the roller 17 also moves further in the front-upper direction. The shaft 17a, while being in contact with the front-upper inclined surface of the support portion 14, can further smoothly move together with the roller 17 along the front-upper inclined surface. Further, the shaft 17a also rotates counterclockwise together with the roller 17.

As described above, since the support portion 14 movably supports the shaft 17a of the roller 17, the first sheet of paper P1 overlaid on the second sheet of paper P2 and transported can smoothly move the shaft 17a together with the roller 17. In other words, the support portion 14 can support the roller 17 while freely moving the roller 17 together with the shaft 17a even when the next first sheet of paper P1 overlaps with the second sheet of paper P2.

The roller 17 is pressed by the tip of the first sheet of paper P1 and can move so as to float while rotating. Therefore, the tip of the first sheet of paper P1 can easily slide into the lower side of the roller 17 while being overlaid on the second sheet of paper P2. That is, by the support portion 14 having such a configuration, a load when the tip of the first sheet of paper P1 enters the gap between the first guide 15 and the roller 17 while being overlaid on the second sheet of paper P2 is reduced, and the tip can be easily entered.

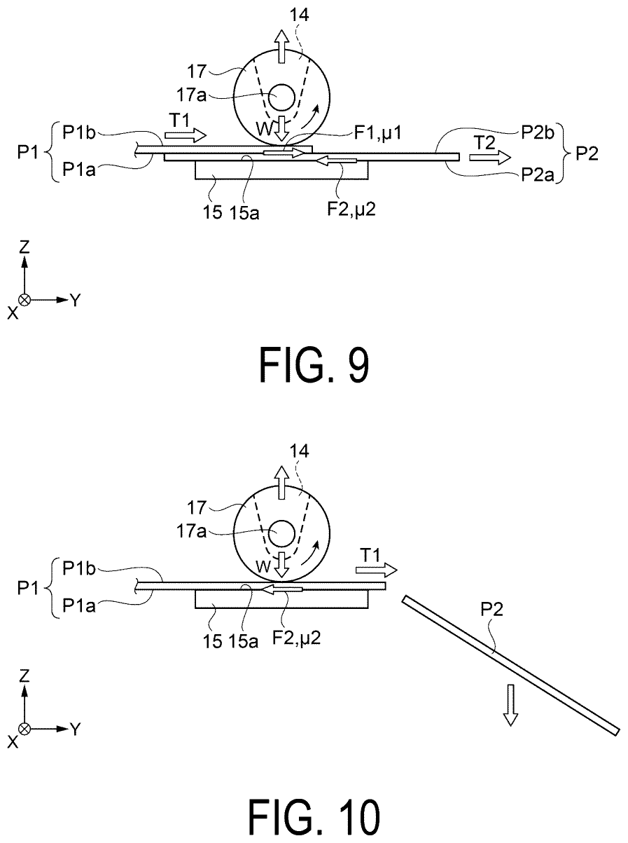

As illustrated in FIG. 9, when the next first sheet of paper P1 is further transported in the transport direction T1, the first sheet of paper P1 advances while being nipped between the roller 17 and the first guide 15 and being overlaid on the second sheet of paper P2. The roller 17 is pressed by the first sheet of paper P1 and the second sheet of paper P2 and moves to the upper side by the thickness of the first sheet of paper P1 and a thickness of the second sheet of paper P2.

The first sheet of paper P1 and the second sheet of paper P2 are nipped between the roller 17 and the first guide 15, and applied with the pressing force W of the roller 17. At this time, the first sheet of paper P1 transported in the transport direction T1 is about to press the second sheet of paper P2 in a movement direction T2.

A friction coefficient between a second surface P2b of the second sheet of paper P2 and the first surface P1a of the first sheet of paper P1 is a first friction coefficient μ1.

A first friction force F1 is generated between the second surface P2b of the second sheet of paper P2 and the first surface P1a of the transported first sheet of paper P1. The first friction force F1, the first friction coefficient μ1, and the pressing force W by the roller 17 have a relationship of F1=μ1×W. That is, the first friction force F1 has a value obtained by multiplying the first friction coefficient μ1 by the pressing force W. Note that the first friction coefficient μ1 may be in a range of 0.3 to 1.0.

On the other hand, as described above, the second friction force F2 due to the second friction coefficient μ2 is generated between the sheet 15a of the first guide 15, and the first surface P2a of the transported second sheet of paper P2 in the direction opposite to the transport direction T1.

Since the friction coefficient of the sheet 15a is smaller than that of the sheet of paper P, a relationship of the second friction coefficient μ2<the first friction coefficient μ1 is established. For example, the second friction coefficient μ2 in the range of 0.05 to 0.2 is smaller than the first friction coefficient μ1 in the range of 0.3 to 1.0.

Since μ2<μ1, (F2=μ2×W)<(F1=μ1×W), that is, F2<F1. Thus, due to the sheet 15a, the second friction force F2 is smaller than the first friction force F1. The second sheet of paper P2 is in a state of easily slipping on the sheet 15a of the first guide 15 on the lower side, with respect to the first sheet of paper P1 overlaid thereon.

In the second sheet of paper P2, the second friction force F2 is applied to the first surface P2a in the direction opposite to the transport direction T1, and the first friction force F1 is applied to the second surface P2b in the transport direction T1.

Then, since F2<F1, the first friction force F1 acting on the second sheet of paper P2 in the transport direction T1 is larger than the second friction force F2 in the direction opposite to the transport direction T1.

As a result, on the second sheet of paper P2, a force of (F1−F2)=(μ1−μ2)×W acts in the forward direction which is the transport direction T1 and is also the movement direction T2. The second sheet of paper P2 is to be pressed and moved by this force in the forward direction which is the transport direction T1 and is also the movement direction T2 by the transported first sheet of paper P1.

That is, the platen roller 30 of the roll paper printer 1, by transporting the first sheet of paper P1 before being cut by the cutter 40, can move the second sheet of paper P2 cut by the cutter 40 so as to be pushed out.

As illustrated in FIG. 10, when the first sheet of paper P1 is further transported along the transport direction T1, the second sheet of paper P2 is further pressed and moved. When the second sheet of paper P2 is pressed by the first sheet of paper P1 and a rear end of the second sheet of paper P2 comes off the roller 17 and the first guide 15, the pressing force W of the roller 17 does not act on the second sheet of paper P2, and the second sheet of paper P2 falls from the first guide 15. That is, the second sheet of paper P2 falls from the issue port 102 of the information terminal device 100.

For example, there is a case where the customer does not remove the second sheet of paper P2 issued as a receipt and held on the first guide 15, from the issue port 102. In this case, by the configuration of the paper guide 10 as described above, it is possible to drop the second sheet of paper P2 which is not removed and remains on the first guide 15 from the issue port 102.

It is possible to prevent the customer from erroneously taking out, instead of the next first sheet of paper P1 which is a newly issued receipt, the second sheet of paper P2 which is a previously issued receipt.

Note that the roller 17 is pressed by the first sheet of paper P1 present between the roller 17 and the first guide 15, and is moved to the upper side from the position illustrated in FIG. 5 by the thickness of the first sheet of paper P1.

The information terminal device 100 according to the above-described embodiment includes the roll paper printer 1 that pulls out the first sheet of paper P1 from the roll paper R, performs printing, and cuts the first sheet of paper P1, the paper guide 10 that guides the first sheet of paper P1, and the issue port 102 through which the first sheet of paper P1 is discharged. Then, the paper guide 10 includes the first guide 15 that guides the first surface P1a of the first sheet of paper P1, the roller 17 that guides the second surface P1b that is the opposite surface of the first surface P1a of the first sheet of paper P1 at a position facing the first guide 15, and the support portion 14 that can movably support the shaft 17a of the roller 17.

According to the above-described information terminal device 100, the first sheet of paper P1 and the cut second sheet of paper P2 can be guided and held by the first guide 15 and the roller 17. In addition, since the support portion 14 movably supports the shaft 17a of the roller 17, the first sheet of paper P1 can move the shaft 17a together with the roller 17 and can easily enter the gap between the first guide 15 and the roller 17. Further, when the second sheet of paper P2 remains on the first guide 15, the second sheet of paper P2 can be dropped from the issue port 102 by the first sheet of paper P1.

These are detailed description of the embodiments with reference to the drawings. However, specific configurations are not limited to the embodiments, and may be modified, replaced, deleted, or the like, provided that these do not depart from the main point of the present disclosure.

The head 20 of the roll paper printer 1 has been described using the example of the thermal head, but any printing method may be used. The head 20 may be, for example, an ink jet head. In this case, since the ink jet head cannot come into contact with the platen roller 30 and nip the first sheet of paper P1, it is sufficient that a driven roller that faces the platen roller 30 and nips the first sheet of paper P1 is mounted at the printer case 3. In addition, in this case, the first sheet of paper P1 may be of plain paper or the like.

In the above description, the example has been described in which the platen roller 30, and the first blade 41 constituting the cutter 40 are mounted at the cover 2 of the roll paper printer 1, and the head 20 and the second blade 42 are mounted at the printer case 3. However, these components may be mounted at the cover 2 and the printer case 3 in a reverse manner. In this case, in the roll paper R, the first sheet of paper P1 is wound around so that an outer side becomes a printing surface.

Further, the first sheet of paper P1 may be label paper in which labels are attached to a mount at predetermined intervals. The information terminal device 100 may include an accommodation box for accommodating the dropped second sheet of paper P2 on a lower side of the issue port 102.

What is claimed is:

1. An information terminal device, comprising:
a roll paper printer configured to pull out paper from paper roll, perform printing, and cut the paper;
a paper guide configured to guide the paper; and
an issue port through which the paper is discharged, wherein the paper guide includes
a first guide for guiding a first surface of the paper,
a roller for guiding a second surface of the paper being a surface opposite to the first surface at a position facing the first guide, and
a support portion permitted to movably support a shaft of the roller.

2. The information terminal device according to claim 1, wherein
the paper guide includes
a second guide disposed on a side opposite to the first guide with the roller interposed, and
the support portion is provided at the first guide or the second guide.

3. The information terminal device according to claim 1, wherein
the support portion of the paper guide has an arc shape on a side of the first guide, and has a groove or a long hole extending in a direction away from the first guide.

4. The information terminal device according to claim 1, wherein
the first guide of the paper guide is covered with a sheet having a friction coefficient smaller than that of the paper.

5. The information terminal device according to claim 4, wherein
when the roller of the paper guide comes into contact with the sheet, the shaft of the roller is permitted to be located so as not to come into contact with the support portion.

6. The information terminal device according to claim 1, wherein
the roll paper printer, by transporting a first sheet of paper before being cut, is permitted to move a second sheet of paper that is cut and located between the first guide and the roller.

7. The information terminal device according to claim 1, wherein
the paper guide includes
a first opening through which the paper discharged from the roll paper printer is permitted to enter,
a second opening that is in communication with the first opening and through which the paper is permitted to be put out to the issue port, and
a third opening through which the paper is permitted to be put out in a direction different from the second opening.

8. A roll paper printer for incorporation with an information terminal device including a paper guide including a first guide for guiding a first surface of paper, a roller for guiding a second surface of the paper being a surface opposite to the first surface at a position facing the first guide, and a support portion permitted to movably support a shaft of the roller, and an issue port through which the paper is discharged, the roll paper printer comprising:
a platen roller configured to pull out the paper from roll paper and configured to transport the paper to the issue port via the paper guide;
a head configured to perform printing on the paper at a position facing the platen roller; and
a cutter configured to cut the paper.

9. A paper guide for guiding paper discharged from a roll paper printer that pulls out the paper from paper roll, performs printing, and cuts the paper, the paper guide comprising:
a first guide configured to guide a first surface of the paper;
a roller configured to guide a second surface of the paper being a surface opposite to the first surface at a position facing the first guide; and
a support portion configured to movably support a shaft of the roller.
